(19) United States
(12) Patent Application Publication
(10) Pub. No.: US 2011/0252759 A1
(43) Pub. Date: Oct. 20, 2011

(54) FILTER

(75) Inventor: Timothy John Nicholas, Southampton (GB)

(73) Assignee: General Electric Company

(21) Appl. No.: 12/760,767

(22) Filed: Apr. 15, 2010

(51) Int. Cl. B01D 46/40

(52) U.S. Cl. 55/497

(57) ABSTRACT

A filter assembly includes a frame for mounting the filter assembly. The frame defines a rectangular opening. A channel is disposed about at least a portion of the periphery of the rectangular opening. Filter media pleat pack is disposed in the channel in the frame. The filter media pleat pack extends across the entire rectangular opening in the frame. The filter media pleat pack separates particles from a gas flowing through the filter media in a first direction. Support structure is connectable with the frame. The support structure engages the filter media pleat pack to limit movement of the filter media pleat pack when gas flows in the first direction through the filter media.

### BACKGROUND OF THE INVENTION

The present invention is generally directed to a filter. In particular, the present invention is directed to an improved filter for use in a gas turbine intake system.

Power generation equipment, such as gas turbines, uses a large quantity of intake air for combustion. To maintain suitable performance of the gas turbine, the intake air is filtered to remove unwanted dust, moisture, and other contaminants that can damage components of the gas turbine. The filters that primarily filter the intake air are typically arranged in an array on a frame located within a housing.

The known filters may be a V-cell mini-pleat type of static filter. That is, each filter has a series of paired flat panel filtration media arranged in a V-shape and connected together at an apex. The known filters include a frame that defines a plurality of rectangular openings. A respective flat panel filtration media spans each of the rectangular openings.

The size of the rectangular opening that the flat panel filtration media must span is important and determines the volume of air that can pass though the known filter. The size of the rectangular opening of typical known filters is approximately 20 inches wide and 12 inches high. The pleat tips and valleys extend in a direction substantially parallel to the height and are glued in a direction that extends substantially parallel to the width.

The known filters may be subjected to a “bowing” condition of the flat panel filtration media under certain conditions. That is at a predetermined force, such as a relatively large pressure drop across the flat panel filtration media, the flat panel filtration media deflects or moves in the direction of air flow. This deflection or movement can damage the flat panel filtration media and adversely affect filtration performance and service life.

It is, therefore, advantageous to provide a filter assembly that offers increased service life by limiting movement of the filter media during air flowing through the filtration portions. It is advantageous to provide a filter assembly that offers increased air flow through it.

### BRIEF DESCRIPTION OF THE INVENTION

The invention, according to at least one aspect, offers a filter assembly that includes a frame for mounting the filter assembly. The frame defines a rectangular opening. A channel is disposed about at least a portion of the periphery of the rectangular opening. Filter media pleat pack is disposed in the channel in the frame. The filter media pleat pack extends across the entire rectangular opening in the frame. The filter media pleat pack separates particles from a gas flowing through the filter media in a first direction. Support structure is connectable with the frame. The support structure engages the filter media pleat pack to limit movement of the filter media pleat pack when gas flows in the first direction through the filter media.

Another aspect of the invention is a V-cell filter assembly including a frame for mounting the filter assembly and defining a rectangular opening. A channel is formed in the frame and disposed about a portion of the periphery of the rectangular opening. Filter media pleat pack is disposed in the channel in the frame and extends across the rectangular opening in the frame. The filter media pleat pack separates particles from a gas flowing through the filter media in a first direction. Support structure is connectable with the mounting portion and the end portion of the frame. The support structure engages the filter media pleat pack to limit movement of the filter media pleat pack when gas flows in the first direction through the filter media. The filter media pleat pack is substantially undamaged when exposed to a force due to gas flowing in the first direction at a differential gauge pressure across the filter media pleat pack of at least six inches of water.

Yet another aspect of the invention is a filter assembly including a frame for mounting the filter assembly and defining a rectangular opening. A channel is formed in the frame and disposed about a portion of the periphery of the rectangular opening. Filter media pleat pack is disposed in the channel in the frame and extends across the rectangular opening in the frame. The filter media pleat pack separates particles from a gas flowing through the filter media in a first direction. Support structure is connectable with the mounting portion and the end portion of the frame. The support structure engages the filter media pleat pack to limit movement of the filter media pleat pack when gas flows in the first direction through the filter media. The filter media pleat pack is substantially undamaged when exposed to a force due to gas flowing in the first direction at a differential gauge pressure across the filter media pleat pack of at least six inches of water.

### BRIEF DESCRIPTION OF THE DRAWINGS

Further features of the invention will become apparent to those skilled in the art to which the invention relates from reading the following description with reference to the accompanying drawings, in which:

FIG. 1 is a is a schematic view of a filter assembly, constructed according to one aspect of the invention, for use with an air intake system of a gas turbine;

FIG. 2 is an enlarged perspective view of a portion of the air intake system illustrated in FIG. 1;

FIG. 3 is a perspective view of the filter assembly, according to one aspect of the invention, for use in the air intake system illustrated in FIGS. 1-2;

FIG. 4 is an elevation view of the filter assembly illustrated in FIG. 3;

FIG. 5 is a perspective view of a portion of the filter assembly, according to one aspect of the invention;

FIG. 6 is an exploded perspective view of the portion of the filter assembly illustrated in FIG. 5;

FIG. 7 is a an enlarged cross-sectional view of an end portion of the filter assembly; and

FIG. 8 is an enlarged perspective view of a portion of the filter assembly.

### DETAILED DESCRIPTION OF THE INVENTION

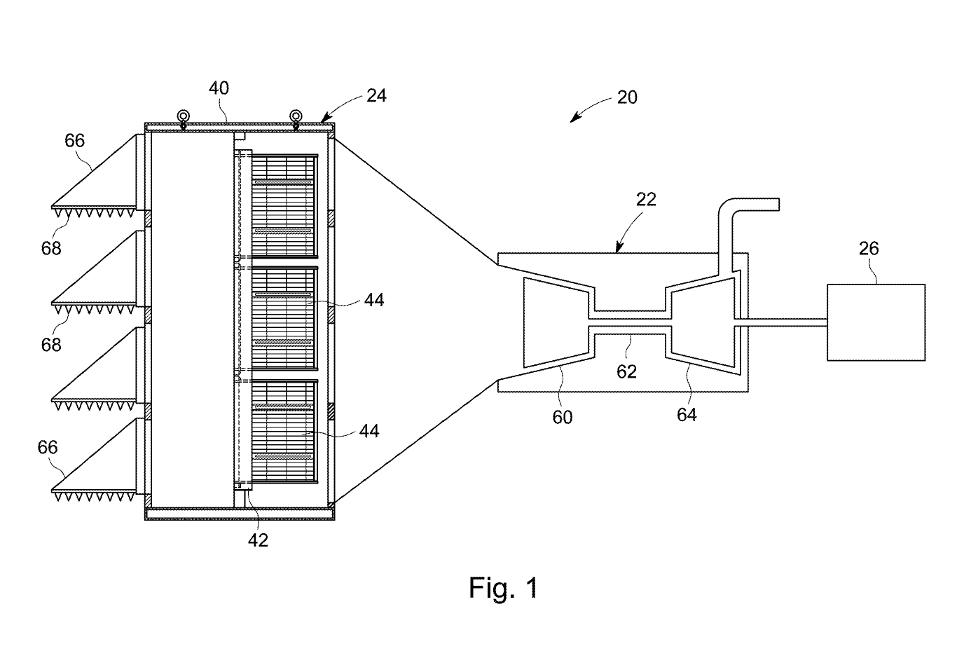

A power generation unit 20 is illustrated in FIG. 1. The power generation unit 20 includes a gas turbine 22 and an intake air filter system 24. Air from the surrounding environment is drawn into the intake air filter system 24 for filtration and delivery to the gas turbine 22. The power generation unit 20 may be used in any of numerous applications, such as without limitation generating electrical power by means of a generator 26 or providing motive power, directly or indirectly.

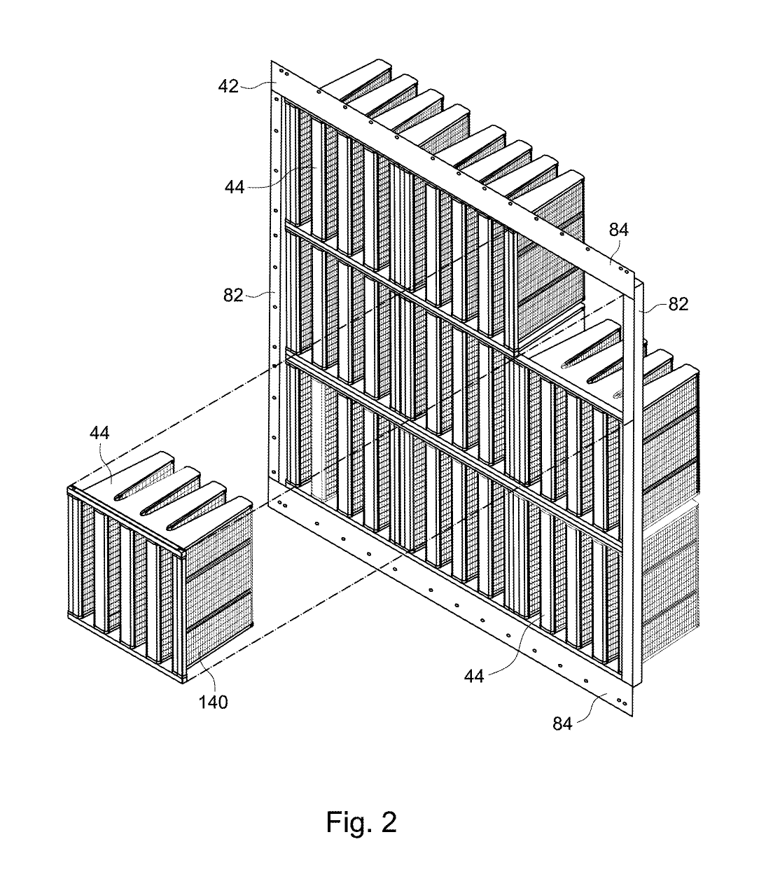

The intake air filter system 24 includes a housing 40. The housing 40 is made from any suitable material, such as sheet metal. The housing 40 supports a frame 42. The frame 42 (FIG. 2) is made from any suitable material, such as metal tubes, channels, beams or extrusions that are fixed to one another by suitable attachment means such as welding. The frame 42 supports a plurality of filter assemblies or filters 44, according to one aspect of the invention. The filters 44 remove contaminants such as dust, dirt, moisture, salt, carbon and other contaminants from the air flowing therethrough in one direction. The contaminants may tend to reduce the performance or service life of the gas turbine 22. The housing 40 may be several stories high, and may contain up to several hundred filters 44, which may be held by several frames 42.

The gas turbine 22 (FIG. 1) includes an air compressor section 60 that draws intake air into the gas turbine 22 for combustion in a combustor section 62 and work in a turbine section 64. The air is drawn first from the surrounding environment through hoods 66 of the housing 40. As the intake air enters the housing 40 through the hoods 66, it may first pass through a prefilter or a de-mister 68. The air then flows through the array of filter assemblies 44 for primary or final filtration before it is directed to the compressor section 60.

As illustrated in FIG. 2, the frame 42 includes a set of vertical supports 82 and horizontal supports 84 that support an array of the filter assemblies 44. The filter assemblies 44 may be held in place by any suitable means, such as clamps or latches (not shown). The filter assemblies 44 may be any suitable type, such as static V-cell mini-pleat filter cartridges, for example. In some embodiments, the filter assemblies 44 may be constructed as high-efficiency AltairSupernova™ filters, available from General Electric Company. The filter assemblies 44 may be of any suitable size, construction, configuration or material.

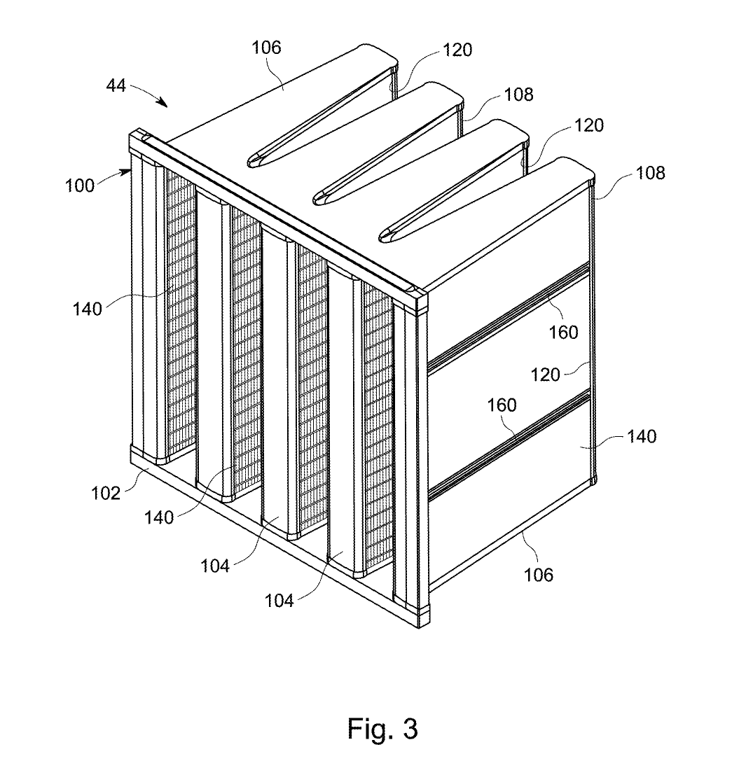

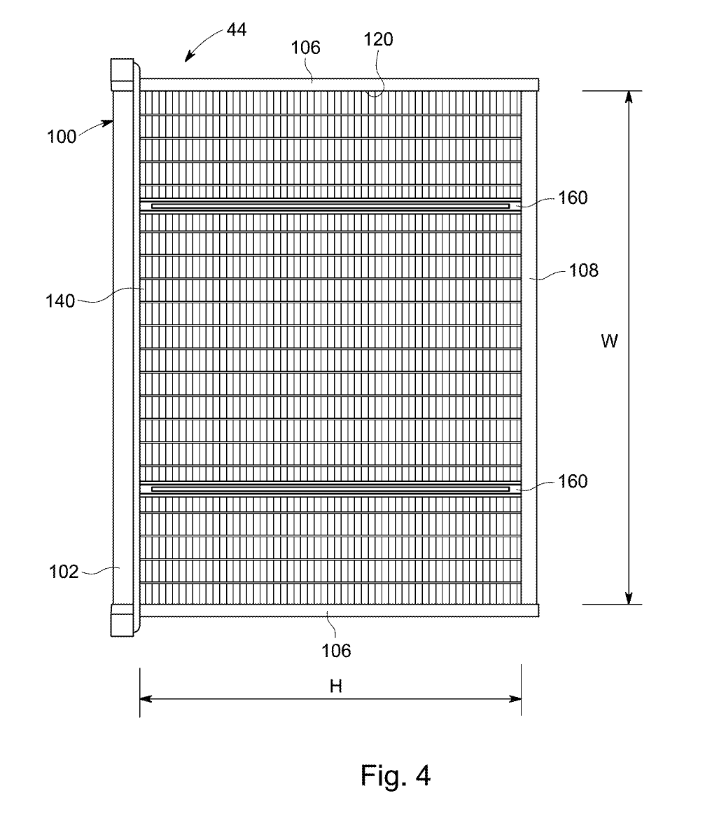

Each filter assembly 44 (FIGS. 3-4) includes a filter frame 100 constructed according to one aspect of the invention. The filter frame 100 mounts the filter assembly 44 in the housing frame 42. The filter frame 100 is preferably made of injection molded plastic. The filter frame 100 has a flange 102 that is connectible with the frame 42 to mount the filter assembly within the housing frame 42. A gasket (not shown) may be disposed around the periphery of the flange 102 and located between the filter assembly 44 and the frame 42 to provide an airtight seal between the filter assembly and the frame.

The filter frame 100 includes a plurality of front rails 104 extending between opposite sides of the flange 102. A pair of side rails or “end caps” 106 are attached to and extend away from the flange 102. The filter frame 100 also has a plurality of rear rails 108 extending between the end caps 106. The number of rear rails 108 used is typically one less than the number of front rails 104.

The filter frame 100 defines a plurality of rectangular openings 120. That is, each assembly of a front rail 104, a pair of end caps 106 and a rear rail 108 define a respective rectangular opening 120. Each rectangular opening 120 has a standard width W (FIG. 4) in the range of about 20 inches. Each rectangular opening 120 also has a height H in the range of 10 inches to 20 inches and preferably in the range of 11 inches to 18 inches. It will be apparent that any suitable size of rectangular opening 120 may be used.

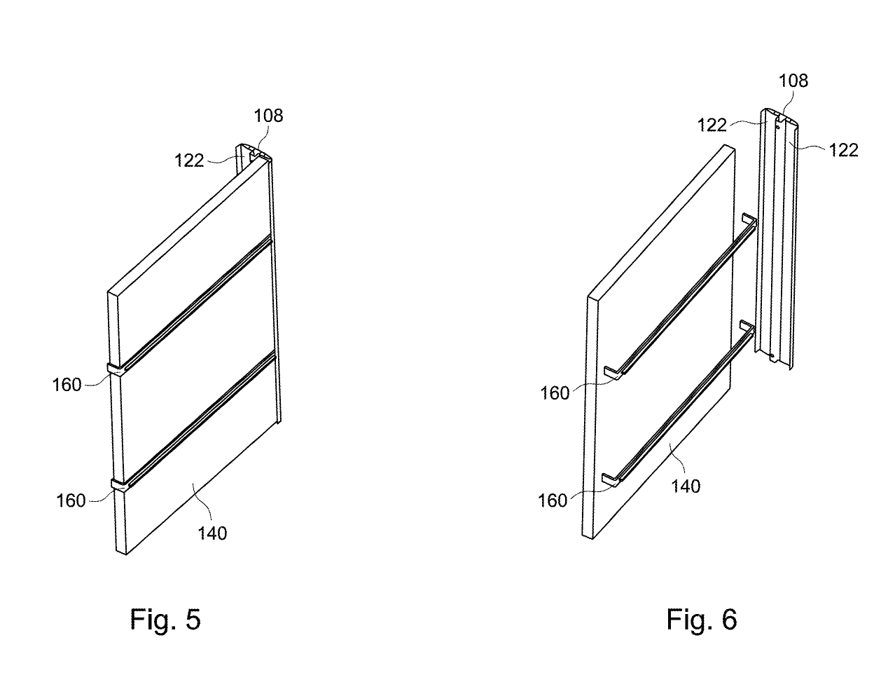

A channel 122 (FIGS. 5-7) is formed in at least portions of the front rail 104, a pair of end caps 106 and a rear rail 108 of the filter frame 100. Preferably, the channel 122 is formed in the filter frame 100 so it is continuous and extends about the entire periphery of the rectangular opening 120.

Each filter assembly 44 includes a plurality of filter media pleat packs 140. The filter media pleat pack 140 is preferably in the form of a “flat panel” as best seen in FIGS. 5-6. Each filter media pleat pack 140 is disposed in a respective channel 122 in the filter frame 100. The filter media pleat pack 140 extends across the entire rectangular opening 120 in the filter frame 100. The filter media pleat pack 140 separates particles from a gas flowing through the filter media pleat pack in a first direction of normal cleaning flow that is communicated to the gas turbine 22. The filter media pleat pack 140 is made from any suitable material, such synthetic fiber, micro-glass or a combination thereof.

The filter media pleat pack 140 occupies a relatively large area, compared to previously known pleat packs. Thus, the filter media pleat pack 140 provides a relatively larger volume of filtration area for air to pass through it and be cleaned for use in the gas turbine 22. The filter media pleat pack 140 has pleat tips that extend in a direction substantially parallel to the direction that the width W is taken across.

Each filter assembly 44 includes a plurality of support structures 160. Each support structure 160 is connected to the filter frame 100 at opposite ends and extends across the filter media pleat pack 140. The support structure 160 engages the filter media pleat pack 140 to limit movement of the filter media pleat pack when gas flows in the first direction through the filter media pleat pack. Two support structures 160 are shown used with each filter media pleat pack 140 in the exemplary embodiment. It will be apparent that any suitable number of support structures may be used with each filter media pleat pack 140.

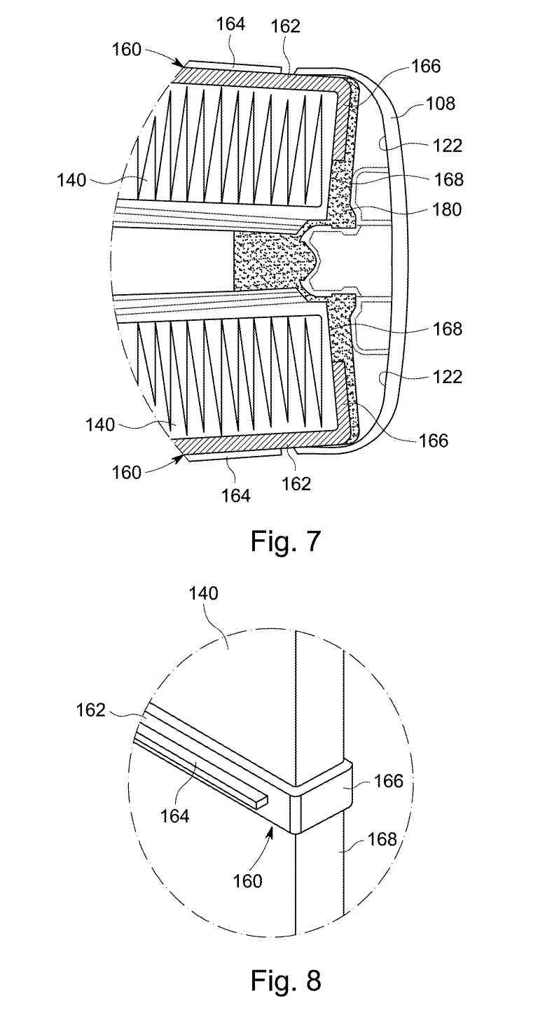

The support structure 160 has essentially a T-shaped cross section over most of its length. It will be apparent that the support structure 160 may have any suitable cross section, such as C-shaped, U-shaped or I-shaped. The support structure 160 has a member 162 (FIGS. 7-8) with a stiffener portion 164. The support structure 160 also has a pair of end portions 166 to retain the support structure in the filter frame 100. The end portions 166 extend around the end surface 168 of a filter media pleat pack 140. The end portions 166 are connected with the filter frame 100 by means of a suitable adhesive 180 located in the channel 122 in, for example, the rear rail 108 of the filter frame. The support structure 160 can be made of any suitable material for the environment it will be used in, such as plastic or metal. For example, the support structure 160 could be a molded plastic component. The support structure 160 could also be made from two metal components that are bonded together, such as by welding. The support structure 160 may be glued to the exit surface of the filter media pleat pack 140.

The filter media pleat pack 140 occupies a flow area within the rectangular opening 120. The width of the support structure 160 is about one inch. Thus, the total area of two support structures 160 extending across the rectangular opening 120 is less than about 10% of the occupied flow area and has little or no impact on air flow through the filter media pleat pack 140.

Testing was done on a filter assembly 44 made according to one aspect of the invention and a previously known filter assembly without a support structure. Testing showed that the filter media pleat pack 140 is substantially undamaged due to bowing when exposed to a force from gas flowing in the first direction at a differential gauge pressure across the filter media pleat pack of at least about six inches of water, preferably of at least about twelve inches of water and more preferrably of at least about fifteen inches of water. Testing also showed that without the support structure 160 tears in the filter media pleat pack due to bowing occurred at about six inches of water.

It is known that during the service life of a filter assembly that the filter media pleat pack collects particulates from the air passing thorough it. This typically increasing the pressure drop across the filter media pleat pack which tends to increase the tendency to bow and cause damage. By providing a filter assembly 44 with the support structure 160 of the present invention, increased service life of the filter assembly can be obtained.

From the above description of at least one aspect of the invention, those skilled in the art will perceive improvements, changes and modifications. Such improvements, changes and modifications within the skill of the art are intended to be covered by the appended claims.

What is claimed is:

1. A filter assembly comprising:
a frame for mounting the filter assembly and defining a rectangular opening;
a channel disposed about at least a portion of the periphery of the rectangular opening;
filter media pleat pack disposed in the channel in the frame and extending across the entire rectangular opening in the frame, the filter media pleat pack for separating particles from a gas flowing through the filter media in a first direction; and
support structure connectable with the frame, the support structure for engaging the filter media pleat pack to limit movement of the filter media pleat pack when gas flows in the first direction through the filter media.

2. The filter assembly of claim 1 wherein the support structure comprises a member with a stiffener portion.

3. The filter assembly of claim 2 wherein the support structure has a T-shaped cross-section across at least a portion of the support structure.

4. The filter assembly of claim 1 wherein the filter media pleat pack is substantially undamaged when exposed to a force due to gas flowing in the first direction at a differential gauge pressure across the filter media pleat pack of at least six inches of water.

5. The filter assembly of claim 4 wherein the filter media pleat pack is substantially undamaged when exposed to a force due to gas flowing in the first direction at a differential gauge pressure across the filter media pleat pack of at least twelve inches of water.

6. The filter assembly of claim 1 wherein the filter assembly is in the form of a V-cell mini-pleat filter and includes a plurality of rectangular openings in the frame and a plurality filter media pleat packs with one of the filter media pleat packs disposed in a respective one of the rectangular openings in the frame.

7. The filter assembly of claim 1 wherein the filter media pleat pack is in the form of a flat panel.

8. The filter assembly of claim 1 wherein the filter media pleat pack occupies a flow area within the rectangular opening in the frame and wherein the support structure extends across less than about 10% of the flow area.

9. The filter assembly of claim 1 wherein the rectangular opening defined by the frame has a width and a height that is smaller than the width and wherein the height is in the range of about 11 inches to 18 inches.

10. A V-cell filter assembly comprising:
a frame for mounting the filter assembly and defining a rectangular opening;
a channel formed in the frame and disposed about a portion of the periphery of the rectangular opening;
filter media pleat pack disposed in the channel in the frame and extending across the rectangular opening in the frame, the filter media pleat pack for separating particles from a gas flowing through the filter media in a first direction; and
support structure connectable with the mounting portion and the end portion of the frame, the support structure for engaging the filter media pleat pack to limit movement of the filter media pleat pack when gas flows in the first direction through the filter media wherein the filter media pleat pack is undamaged when exposed to a force due to gas flowing in the first direction at a differential gauge pressure across the filter media pleat pack of at least six inches of water.

11. The V-cell filter assembly of claim 10 wherein the support structure comprises a member with a stiffener portion.

12. The V-cell filter assembly of claim 10 wherein the filter media pleat pack occupies a flow area within the rectangular opening in the frame and wherein the support structure extends across less than about 10% of the flow area.

13. The V-cell filter assembly of claim 10 wherein the rectangular opening defined by the frame has a width and a height that is smaller than the width and wherein the height is in the range of about 11 inches to 18 inches.

14. The V-cell filter assembly of claim 10 wherein the filter media pleat pack is substantially undamaged when exposed to a force due to gas flowing in the first direction at a differential gauge pressure across the filter media pleat pack of at least twelve inches of water.

15. A filter assembly comprising:
a frame for mounting the filter assembly and defining a rectangular opening;
a channel formed in the frame and disposed about a portion of the periphery of the rectangular opening;
filter media pleat pack disposed in the channel in the frame and extending across the rectangular opening in the frame, the filter media pleat pack for separating particles from a gas flowing through the filter media in a first direction; and
support structure connectable with the frame, the support structure for engaging the filter media pleat pack to limit movement of the filter media pleat pack when gas flows in the first direction through the filter media so the filter media pleat pack is undamaged when exposed to a force due to gas flowing in the first direction at a differential gauge pressure across the filter media pleat pack of at least six inches of water.

16. The filter assembly of claim 15 wherein the support structure comprises a member with a stiffener portion.

17. The filter assembly of claim 15 wherein the filter assembly is in the form of a V-cell mini-pleat filter.

18. The filter assembly of claim 15 wherein the rectangular opening defined by the frame has a width and a height that is smaller than the width and wherein the height is in the range of about 11 inches to 18 inches.

19. The filter assembly of claim 15 wherein the filter media pleat pack has a plurality of substantially parallel extending pleat tips that extend in a direction that is substantially parallel to the width.

20. The filter assembly of claim 15 wherein the filter media pleat pack is substantially undamaged when exposed to a force due to gas flowing in the first direction at a differential gauge pressure across the filter media pleat pack of at least twelve inches of water.
